(19) United States
(12) Patent Application Publication
(10) Pub. No.: US 2025/0209619 A1
(43) Pub. Date: Jun. 26, 2025

(54) IMAGE PROCESSING APPARATUS, IMAGE PROCESSING METHOD, AND COMPUTER PROGRAM

(71) Applicants: National Cancer Center, Tokyo (JP); Canon Kabushiki Kaisha, Tokyo (JP); CANON MEDICAL SYSTEMS CORPORATION, Tochigi (JP)

(72) Inventors: Fumihiko NAKATANI, Chuo-ku (JP); Kazuhiro MIYASA, Narashino (JP); Toshimizu YAMANE, Ohta-ku (JP)

(73) Assignees: National Cancer Center, Tokyo (JP); Canon Kabushiki Kaisha, Tokyo (JP); CANON MEDICAL SYSTEMS CORPORATION, Tochigi (JP)

(21) Appl. No.: 18/990,789

(22) Filed: Dec. 20, 2024

(30) Foreign Application Priority Data
Dec. 21, 2023 (JP) 2023-216128

(51) Int. Cl. G06T 7/00; G06T 5/20; G06V 10/75

(52) U.S. Cl. CPC G06T 7/0012; G06T 5/20; G06V 10/751; G06T 2207/10081; G06T 2207/30096

(57) ABSTRACT

An image processing apparatus according to an embodiment includes processing circuitry. The processing circuitry acquires a first image including a first region image in which a common subject is imaged and a second image including a second region image corresponding to the first region image, on the basis of a first pixel value constituting the first region image and a first reference value, estimates the confidence level of the first pixel value, on the basis of a second pixel value constituting the second region image and a second reference value different from the first reference value, estimates the confidence level of the second pixel value and acquires the confidence level of a subtraction value between the first pixel value and the second pixel value on the basis of the confidence level of the first pixel value and the confidence level of the second pixel value.

### CROSS-REFERENCE TO RELATED APPLICATIONS

This application is based upon and claims the benefit of priority from Japanese Patent Application No. 2023-216128, filed on Dec. 21, 2023; the entire contents of which are incorporated herein by reference.

### FIELD

Embodiments described herein relate generally to an image processing apparatus, an image processing method, and a computer program.

### BACKGROUND

In the medical field, diagnoses are performed using images acquired by various medical imaging apparatuses (modalities) such as computed tomography apparatuses (hereinafter, referred to as CT apparatuses). For efficient diagnoses, a technique is needed to visualize changes in lesions over time to aid physicians in their diagnoses.

For example, a technique is needed to visualize tumor infiltration into the spinal canal and measure the degree of infiltration in order to ascertain the risk of bone-related events of bone metastases. As a technique for visualizing changes over time, an image differencing technique is known to support contrast between images by aligning two images taken at different times and displaying a subtraction image that visualizes subtractions between the images.

Beam hardening artifacts are known as noise that tends to occur in regions surrounded by structures with high absorption coefficients, such as bone. Beam hardening occurs when a polychromatic beam passes through a patient and soft (low energy) photons are preferentially absorbed or scattered from the beam, leaving hard photons behind. This beam hardening occurs when an X-ray source and a detector are synchronously rotated in the gantry of the CT apparatus while scanning and imaging the patient. The optical density of a light path passing through the patient differs depending on the position of the X-ray source during scanning and the direction of X-ray exposure, resulting in differences in a line attenuation coefficient. That is, the beam hardening artifacts are caused by a weakening of CT values in the direction through a high absorber, resulting in regions of low CT values during reconstruction.

Japanese Patent Application Laid-open No. 2013-48713 discloses a technique for, based on the correlation between two images obtained by imaging with X-rays of different tube voltages, removing noise by estimating pixel values for each pixel in an artifact region when there are no artifacts from an image with a higher tube voltage.

However, in addition to requiring two imaging sessions at different tube voltages, the technique in Japanese Patent Application Laid-open No. 2013-48713 described above may reduce lesion-specific image features due to the influence of image characteristics of the higher tube voltage. Thus, there is a problem in that a lesion location is not appropriately depicted in a subtraction image.

### BRIEF DESCRIPTION OF THE DRAWINGS

FIG. 1 is a diagram illustrating an example of a configuration of an image processing apparatus according to a first embodiment;

FIG. 2 is a flowchart illustrating a processing procedure performed by the image processing apparatus according to the first embodiment;

FIG. 3 is a data flow diagram illustrating the flow of all data in the image processing apparatus according to the first embodiment;

FIG. 4 is a diagram illustrating an example of a configuration of an image processing apparatus according to a second embodiment;

FIG. 5 is a flowchart illustrating a processing procedure performed by the image processing apparatus according to the second embodiment;

FIG. 6 is a data flow diagram illustrating an entire procedure of the image processing apparatus according to the second embodiment;

FIG. 7 is a diagram illustrating an example of a configuration of an image processing apparatus according to a third embodiment;

FIG. 8 is a flowchart illustrating an entire procedure of the image processing apparatus according to the third embodiment;

FIG. 9 is a data flow diagram illustrating the entire procedure of the image processing apparatus according to the third embodiment;

FIG. 10 is a diagram illustrating an example of an activation function according to the first embodiment;

FIG. 11 is a diagram for explaining an example of weight coefficients for correction 1 of the confidence level of a subtraction value according to an intervertebral foramen level according to the first embodiment;

FIG. 12 is a diagram for explaining an example of weight coefficients for correction 2 of the confidence level of a subtraction value according to the intervertebral foramen level according to the first embodiment;

FIG. 13 is a diagram illustrating an example of displaying an occupancy rate according to the first embodiment in correspondence with a sagittal cross section;

FIG. 14A is a diagram for explaining an example of spinal canal region information according to a first modification;

FIG. 14B is a diagram for explaining another example of spinal canal region information according to the first modification;

FIG. 15 is a diagram for explaining an example of displaying a fusion image in correspondence with the confidence level of a subtraction value in the second embodiment;

FIG. 16 is a diagram for explaining an example of displaying an occupancy rate in correspondence with the confidence level of a subtraction value in the second embodiment;

FIG. 17 is a diagram for explaining an example of the range of attenuating a subtraction and the range of infiltration in the first embodiment; and

FIG. 18 is a diagram illustrating another example of an activation function according to the first embodiment.

### DETAILED DESCRIPTION

One of the problems that the embodiments disclosed herein and in the drawings seek to solve is to allow users, such as physicians, to perform reading using subtractions without load by excluding the influence of noise. However, the problems to be solved by the embodiments disclosed herein and in the drawings are not limited to the above problems. Problems corresponding to each of the effects of each of the configurations shown in the embodiments described below can also be positioned as other problems.

An image processing apparatus according to an embodiment includes processing circuitry. The processing circuitry acquires a first image including a first region image in which a common subject is imaged and a second image including a second region image corresponding to the first region image and different from the first image. On the basis of a first pixel value constituting the first region image and a first reference value, the processing circuitry estimates the confidence level of the first pixel value. On the basis of a second pixel value constituting the second region image and a second reference value different from the first reference value, the processing circuitry estimates the confidence level of the second pixel value. The processing circuitry acquires the confidence level of a subtraction value between the first pixel value and the second pixel value on the basis of the confidence level of the first pixel value and the confidence level of the second pixel value.

Embodiments of an image processing apparatus, an image processing method, and a computer program are described in detail below with reference to the accompanying drawings.

The present disclosure is described in detail below with reference to the accompanying drawings on the basis of preferred embodiments. The configurations shown in the following embodiments are merely examples, and the present disclosure is not limited to the configurations shown in the drawings.

### First Embodiment

A first embodiment describes details of an image processing apparatus that provides diagnostic support for bone metastasis-related events of cancer as an example. In this diagnostic support, bone metastasis, spinal canal infiltration, and perivertebral extraosseous masses are diagnostic targets, and subtraction images (subtraction data) appropriate for visualizing these in the same image are generated. In this description, a spinal cord region within the spinal canal is referred to as a spinal canal region.

The image processing apparatus according to the present embodiment is an apparatus for visualizing a candidate region for spinal canal infiltration and a candidate region for an extraosseous mass in a subject region shown in a target image to be subjected to image processing. Specifically, the image processing apparatus first generates a subtraction image between two time-lapse images being target images. Subsequently, the image processing apparatus extracts the spinal canal from the target image, and further extracts an infiltration candidate region by using the subtraction image, as a candidate region for the spinal canal infiltration, which is an abnormal region in the spinal canal. The image processing apparatus extracts a perivertebral region from the target image, and further extracts a mass candidate region by using the subtraction image, as a candidate region for the extraosseous mass, which is an abnormal region within the perivertebral region. Subsequently, the image processing apparatus performs control of calculating and displaying, as subtraction data, the subtraction image, an image of the infiltration candidate region or the mass candidate region superimposed on the target image, and a graph of index values representing the degree of infiltration or mass.

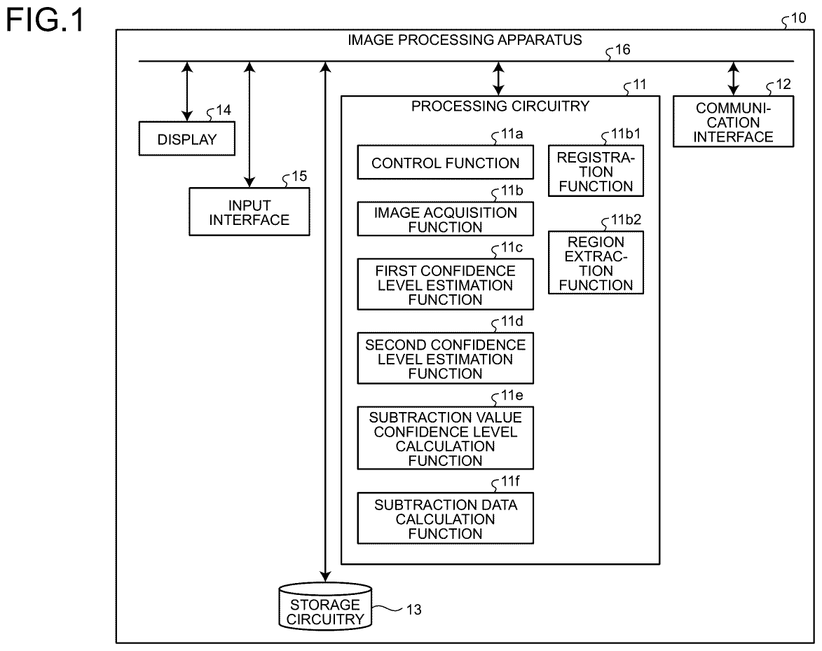

FIG. 1 is a diagram illustrating an example of the configuration of an image processing apparatus 10 according to the first embodiment. As illustrated in FIG. 1, the image processing apparatus 10 includes processing circuitry 11, a communication interface 12, storage circuitry 13, a display 14, an input interface 15, and a connection unit 16. The image processing apparatus 10 is communicably connected to a medical image diagnostic apparatus (modality), a medical image storage apparatus, various departmental systems, and the like via a network (not illustrated).

The medical image diagnostic apparatus includes an X-ray computed tomography (CT) apparatus, a magnetic resonance imaging (MRI) apparatus, an X-ray diagnostic apparatus, and the like. The medical image storage apparatus is implemented by a picture archiving and communication system (PACS) or the like, and stores medical images in accordance with a digital imaging and communications in medicine (DICOM) standard. Each departmental system includes various systems such as a hospital information system (HIS), a radiology information system (RIS), a diagnostic report system, and a laboratory information system (LIS).

The processing circuitry 11 controls the image processing apparatus 10 by performing a control function 11a, an image acquisition function 11b, a first confidence level estimation function 11c, a second confidence level estimation function 11d, a subtraction value confidence level calculation function 11e, and a subtraction data calculation function 11f in response to input operations received from a user via the input interface 15. The processing circuitry 11 further performs a registration function 11b1 and a region extraction function 11b2. The image acquisition function 11b is an example of an image acquisition unit. The first confidence level estimation function 11c is an example of a first confidence level estimation unit. The second confidence level estimation function 11d is an example of a second confidence level estimation unit. The subtraction value confidence level calculation function 11e is an example of a subtraction value confidence calculation unit. The subtraction data calculation function 11f is an example of a subtraction data calculation unit.

The control function 11a generates various graphical user interfaces (GUIs) and various display information in response to operations via the input interface 15, and controls the generated GUIs and display information to be displayed on the display 14. The control function 11a also controls the transmission and reception of information to and from devices and systems on the network (not illustrated) via the communication interface 12. The control function 11a also acquires information on a subject from each departmental system connected to the network. The control function 11a also outputs processing results to the devices and the systems on the network.

The image acquisition function 11b acquires medical image data of the subject taken by the medical image diagnostic apparatus or the like from the medical image storage apparatus or the like on the basis of image reference address information (uniform resource locator (URL), various unique identifiers (UIDs), path character strings, or the like). Specifically, the image acquisition function 11b acquires three-dimensional medical images (volume data) from the modality and the medical image storage apparatus connected to the image processing apparatus 10 via the network. The processing performed by the image acquisition function 11b is described in detail below. The medical image is an example of an image. In the following description, the medical image may simply be referred to as an image.

The registration function 11b1 performs a registration process on the three-dimensional image acquired by the image acquisition function 11b. Specifically, the registration function 11b1 calculates a spatial correspondence between the first image and the second image. Subsequently, the registration function 11b1 generates a deformed image by transforming the coordinates of the second image to match the first image. The processing performed by the registration function 11b1 is described in detail below.

The region extraction function 11b2 extracts the spinal canal region from the image, targeting the three-dimensional image acquired by the image acquisition function 11b or the deformed image generated by the registration function 11b1. The processing performed by the region extraction function 11b2 is described in detail below.

The first confidence level estimation function 11c estimates a confidence level, which represents the degree to which a CT value is considered to represent a lesion due to infiltration, for each pixel value of the first image acquired by the image acquisition function 11b, by using a predetermined reference value. The processing performed by the first confidence level estimation function 11c is described in detail below.

The second confidence level estimation function 11d estimates a confidence level, which represents the degree to which the CT value is considered to be a true CT value unaffected by noise, for each pixel value of the second image acquired by the image acquisition function 11b or for each pixel value of the deformed image generated by the registration function 11b1, by using a reference value different from the reference value used in the first confidence level estimation function 11c. The processing performed by the second confidence level estimation function 11d is described in detail below.

The subtraction value confidence level calculation function 11e calculates the confidence level of a subtraction value between the first pixel value and the second pixel value by using the confidence level of the first pixel value estimated by the first confidence level estimation function 11c and the confidence level of the second pixel value estimated by the second confidence level estimation function 11d. The processing performed by the subtraction value confidence level calculation function 11e is described in detail below.

The subtraction data calculation function 11f calculates subtraction data between the first pixel value and the second pixel value. The processing performed by the subtraction data calculation function 11f is described in detail below.

The processing circuitry 11 described above is implemented by a processor, for example. In such a case, each of the above-mentioned processing functions is stored in the storage circuitry 13 in the form of a computer program executable by a computer. Subsequently, the processing circuitry 11 reads the computer programs stored in the storage circuitry 13 and executes the read computer programs, thereby implementing functions corresponding to the executed computer programs. In other words, the processing circuitry 11 in the state of having read the computer programs has the processing functions illustrated in FIG. 1.

The processing circuitry 11 may be configured by combining a plurality of independent processors and respective processors may implement respective processing functions by executing respective computer programs. Furthermore, the respective processing functions of the processing circuitry 11 may be implemented by being appropriately distributed or integrated into single processing circuitry or a plurality of pieces of processing circuitry. Each processing function of the processing circuitry 11 may be implemented by a mixture of hardware such as circuits and software. Although an example in which the computer program corresponding to each processing function is stored in single storage circuitry 13 is described, the embodiment is not limited thereto. For example, the computer program corresponding to each processing function may be distributed and stored in a plurality of pieces of storage circuitry, and the processing circuitry 11 may be configured to read each computer program from each storage circuitry and execute the read computer program.

The communication interface 12 controls the transmission and communication of various data transmitted/received between the image processing apparatus 10 and other devices or systems connected via the network. Specifically, the communication interface 12 is connected to the processing circuitry 11 and outputs data received from the other devices or the systems to the processing circuitry 11, or transmits data output from the processing circuitry 11 to the other devices or the systems. For example, the communication interface 12 is implemented by a network card, a network adapter, a network interface controller (NIC), or the like.

The storage circuitry 13 stores various data and various computer programs. Specifically, the storage circuitry 13 is connected to the processing circuitry 11 and stores data input from the processing circuitry 11, or reads the stored data and outputs the read data to the processing circuitry 11. For example, the storage circuitry 13 is implemented by a semiconductor memory element such as a random access memory (RAM) and a flash memory, a hard disk, an optical disc, or the like.

The display 14 displays various information and various data. Specifically, the display 14 is connected to the processing circuitry 11 and displays various information and various data output from the processing circuitry 11. For example, the display 14 is implemented by a liquid crystal display, a cathode ray tube (CRT) display, an organic EL display, a plasma display, a touch panel, or the like. The display 14 is an example of a display unit.

The input interface 15 receives input operations of various instructions and various information from a user. Specifically, the input interface 15 is connected to the processing circuitry 11, converts the input operation received from the user into an electrical signal, and outputs the electrical signal to the processing circuitry 11. For example, the input interface 15 is implemented by a trackball, a switch button, a mouse, a keyboard, a touch pad for performing an input operation by touching an operation surface, a touch screen with integrated display screen and touch pad, a non-contact input interface using an optical sensor, a voice input interface, or the like. In this specification, the input interface 15 is not limited to only those with physical operation components such as a mouse and a keyboard. For example, an example of the input interface 15 also includes electrical signal processing circuitry that receives an electrical signal corresponding to an input operation from an external input device provided separately from the apparatus and outputs the electrical signal to the control circuitry.

The connection unit 16 is a bus or the like that connects the processing circuitry 11, the communication interface 12, the storage circuitry 13, the display 14, and the input interface 15 to one another.

In this specification, an axis representing the direction from the right hand to the left hand of a subject is defined as an X-axis, an axis representing the direction from the front to the back of the subject is defined as a Y-axis, and an axis representing the direction from the head to the feet of the subject is defined as a Z-axis. An XY cross section is defined as an axial plane, a YZ cross section is defined as a sagittal plane, and a ZX cross section is defined as a coronal plane. That is, the X-axis direction is a direction (hereafter, a sagittal direction) orthogonal to the sagittal plane. The Y-axis direction is a direction (hereafter, a coronal direction) orthogonal to the coronal plane. Moreover, the Z-axis direction is a direction (hereinafter, an axial direction) orthogonal to the axial plane. In the case of a CT image configured as a set of two-dimensional tomographic images (slice images), the slice plane of the image represents an axial plane, and a direction (hereafter, a slice direction) orthogonal to the slice plane represents the axial direction. Note that this is merely an example of how to take a coordinate system and other definitions may be used.

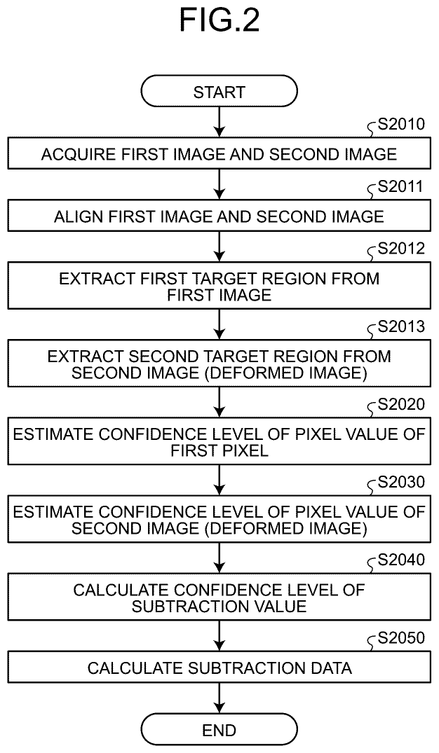

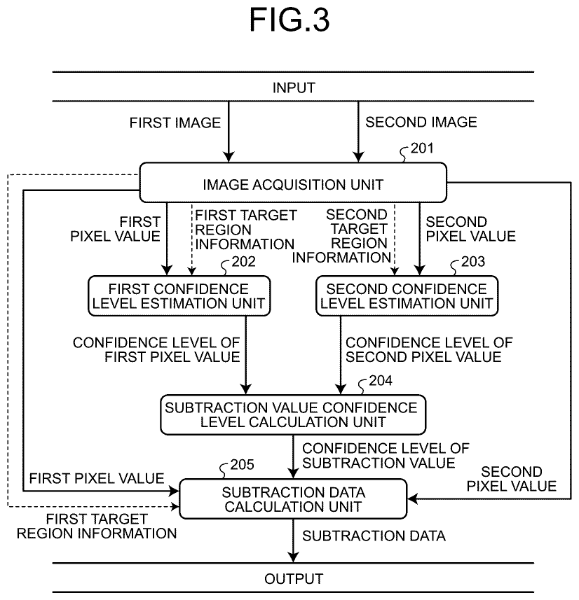

FIG. 2 is a flowchart illustrating a processing procedure performed by the image processing apparatus 10 according to the first embodiment. FIG. 3 is a data flow diagram illustrating the flow of all data in the image processing apparatus 10 according to the first embodiment.

The image processing apparatus 10 receives a current image being the first image and a past image being the second image, and outputs, as subtraction data, a subtraction image indicating a subtraction between the current image and the past image. In this case, the image processing apparatus 10 calculates the confidence level of pixels of each input image, and performs a noise suppression process on the subtraction image on the basis of the calculated confidence level. The images are all three-dimensional volume data. The present embodiment describes the first image and the second image as X-ray CT images. However, the embodiment is not limited thereto, and the present disclosure can also be applied to medical images of other modalities such as magnetic resonance imaging (MRI) images and ultrasound images. The first image and the second image may be a combination of images other than the current image and the past image. For example, the first image and the second image may be a contrast image and a non-contrast image taken during an examination on the same day.

The processing of step S2010 illustrated in FIG. 2 is implemented, for example, by the processing circuitry 11 calling the computer program corresponding to the image acquisition function 11b from the storage circuitry 13 and executing the read computer program. The processing of step S2011 is implemented, for example, by the processing circuitry 11 calling the computer program corresponding to the positioning function 11b1 from the storage circuitry 13 and executing the read computer program. The processing of steps S2012 and S2013 is implemented, for example, by the processing circuitry 11 calling the computer program corresponding to the region extraction function 11b2 from the storage circuitry 13 and executing the read computer program. The processing of step S2020 is implemented, for example, by the processing circuitry 11 calling the computer program corresponding to the first confidence level estimation function 11c from the storage circuitry 13 and executing the read computer program. Moreover, the processing of step S2030 is implemented, for example, by the processing circuitry 11 calling the program corresponding to the second confidence level estimation function 11d from the storage circuitry 13 and executing the read computer program. Moreover, the processing of step S2040 is implemented, for example, by the processing circuitry 11 calling the computer program corresponding to the subtraction value confidence level calculation function 11e from the storage circuitry 13 and executing the read computer program. Moreover, the processing of step S2050 is implemented, for example, by the processing circuitry 11 calling the computer program corresponding to the subtraction data calculation function 11f from the storage circuitry 13 and executing the read computer program.

### Step S2010

As illustrated in FIG. 3, an image acquisition unit 201 acquires the current image being the first image from the PACS or modality by using the image acquisition function 11b, specifies past images of the same patient by using a method to be described below, and acquires the past image being the second image from the PACS.

The following description is given on the assumption that the image to be acquired here is three-dimensional volume data obtained by taking the same site of a patient; however, this acquisition function is not limited thereto and for example, the image may be two-dimensional pixel data.

One method for specifying the past images of the same patient is, for example, to search for, from the PACS or the like, images that have the same patient ID as the first image and are older than the first image in terms of examination date and time, and select an image with the most recent examination date and time from the searched images. This acquisition function may specify past images by other methods or by manual selection of a user.

The second image in the present embodiment is described as an image taken earlier than the first image; however, the implementation of the present disclosure is not limited thereto. For example, the first image may have been taken earlier than the second image, or two images taken at the same time may be the first image and the second image. The first image and the second image may be images with different contrast time phases from each other. The first image and the second image may be taken images of different patients.

### Step S2011

Moreover, the image acquisition unit 201 aligns the current image with the past image by using the registration function 11b1, and calculates the spatial correspondence between the current image and the past image.

The registration function 11b1 can calculate (estimate) the spatial correspondence between images by using existing linear registration algorithms, nonlinear registration algorithms, or a combination of both. The registration function 11b1 can align the positions of feature points indicating characteristic sites included in the current image and feature points indicating characteristic sites included in the past image by deformation registration between the images as described above.

Moreover, on the basis of the results of the registration, the registration function 11b1 generates a deformed image in which the past image is coordinate-transformed to match the current image.

The above example describes a case in which the registration process between the current image and the past image is performed and the deformed image is generated on the basis of the result of the registration process; however, the implementation of the present disclosure is not limited thereto. For example, the deformed image generated by transforming the coordinates of the past image through the process described above may be stored in the PACS or the like, and the image acquisition unit 201 may acquire the image. The current image may also be acquired from an image taken after adjusting the position and posture of a subject in advance to match the past image. In this case, since the current image and the past image have a spatial correspondence, the generation of a deformed image is unnecessary. That is, the past image can be used as is instead of the deformed image in subsequent processing.

### Step S2012

Moreover, the image acquisition unit 201 performs spinal canal segmentation on the current image by using the region extraction function 11b2, and calculates first target region information that specifies a first target region, that is, spinal canal region information.

The region extraction function 11b2 performs the spinal canal segmentation by using known region extraction methods. For example, the region extraction function 11b2 performs segmentation by threshold processing, morphological operations, pattern matching, or an inference device such as U-Net, and extracts spinal canal region information from the current image. However, the region extraction function 11b2 may acquire the spinal canal region information in the current image by user input.

### Step S2013

Moreover, the image acquisition unit 201 also performs the spinal canal segmentation on the deformed image by using the region extraction function 11b2, and calculates second target region information that specifies a second target region, that is, spinal canal region information of the deformed image.

In addition to performing the spinal canal segmentation using known region extraction methods, by using the correspondence between pixels of the current image and the past image calculated by the registration function 11b1, the region extraction function 11b2 may transform the spinal canal region information of the current image to calculate the spinal canal region information of the deformed image.

In FIG. 2, steps S2020 and S2030 are performed as sequential processes, but may also be performed as parallel processes.

### Step S2020

As illustrated in FIG. 3, a first confidence level estimation unit 202 estimates the confidence level of the first pixel value representing the degree to which each pixel (first pixel) in the spinal canal region of the first image is a pixel in a lesion region, on the basis of the current image being the first image acquired by the image acquisition unit 201 and the spinal canal region information of the first image. Specifically, for each of the plurality of pixels (first pixels) in the spinal canal region of the first image, the first confidence level estimation unit 202 calculates a confidence level bi of a first pixel value a₁ being a pixel value of the pixel through the following equation (1) by using the first pixel value and a reference pixel value m₁. The reference pixel value m₁ may use an average pixel value of the spinal canal region in the first image, or a representative value (about 40 HU) as an average CT value in the spinal canal in a healthy subject. A preset value other than the average pixel value of the spinal canal region may also be used.

$${b}_{1} = W ( {a}_{1} - {m}_{1} , {μ}_{1} ) \qquad ( 1 )$$

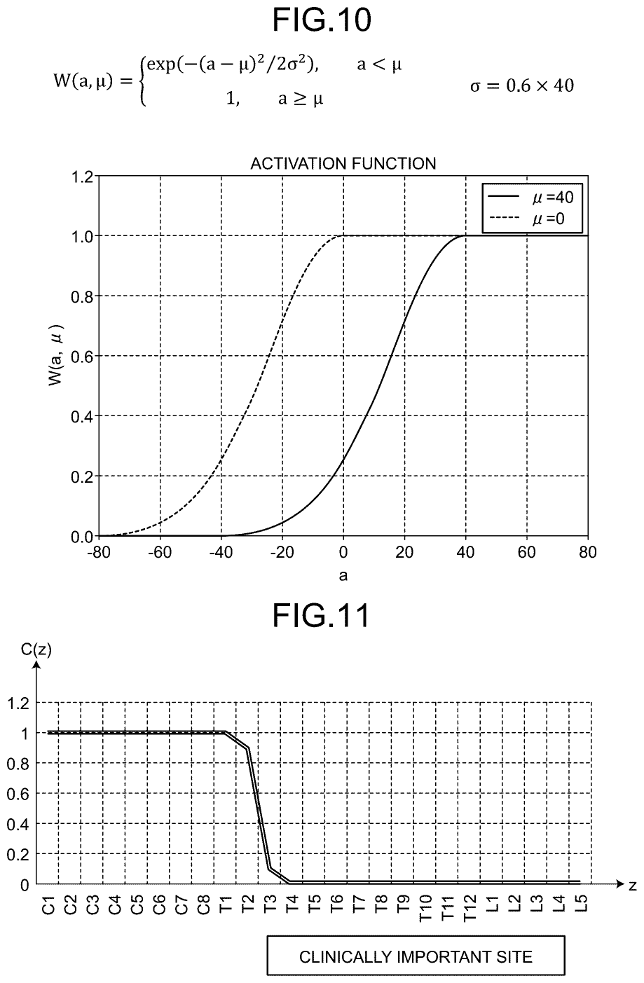

In equation (1) above, W(a, μ) is an activation function that smoothly decays for small values of a around a reference value μ as illustrated in FIG. 10, for example. This function is also used to calculate the confidence level of the second pixel value at step S2030 to be described below, but different reference values are used for each calculation. This is due to the difference that the confidence level of the first pixel value is calculated to indicate that the pixel is a lesion, while the confidence level of the second pixel value is calculated to indicate that the pixel is not affected by noise. The first confidence level estimation unit 202 calculates the confidence level of the first pixel value by using characteristics that the pixel value of a lesion due to infiltration tends to be higher than the average pixel value of pixels also including surrounding regions other than the lesion. Therefore, a reference value μ₁ used to calculate the confidence level of the first pixel value is set to be larger (for example, about 40 HU) than a reference value μ₂ used to calculate the second confidence level to be described below. Specifically, the reference value μ₁ is set to a value with a magnitude corresponding to the difference between the pixel value of the lesion due to infiltration and the average pixel value in the spinal canal.

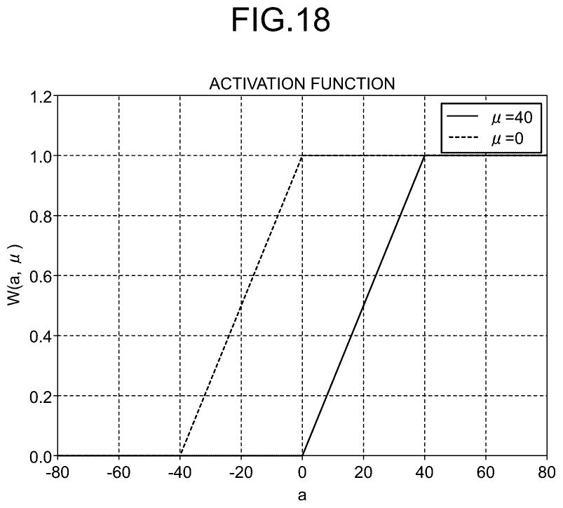

The above method for calculating the confidence level of the first pixel value is merely an example, and the first confidence level estimation unit 202 may calculate the confidence level of the first pixel value by other methods. For example, the first confidence level estimation unit 202 may use, as the activation function, a function in which a function W linearly decreases with a decrease in a around the reference value μ and the range of values is from 0 to 1, as shown in equation (2) below. FIG. 18 illustrates a graph of the activation function W below.

$$W ( a , μ ) = max ( min ( ( a + 40 - μ ) / 40 , 1 ) , 0 ) \qquad ( 2 )$$

The above example describes a case in which a lesion exhibiting a CT value higher than an average CT value in a healthy spinal canal is considered and a higher confidence level in a region in which such a lesion is present is calculated; however, the embodiment is not limited thereto. For example, the first confidence level estimation unit 202 may consider a lesion exhibiting a CT value lower than the average CT value in the healthy spinal canal and calculate a higher confidence level in a region in which such a lesion is present. On the basis of a statistical distribution of CT values in the healthy spinal canal, the first confidence level estimation unit 202 may also calculate the confidence level of the first pixel value from the degree of deviation from the distribution.

### Step S2030

As illustrated in FIG. 3, on the basis of the deformed image obtained by transforming the coordinates of the past image being the second image acquired by the image acquisition unit 201 and the spinal canal region information of the deformed image, a second confidence level estimation unit 203 estimates the confidence level of the second pixel value that represents the degree to which each pixel (second pixel) in the spinal canal region of the deformed image is a pixel outside a noise region. Specifically, for each of the plurality of pixels (second pixels) within the spinal canal region of the deformed image, the second confidence level estimation unit 203 calculates a confidence level b₂ of the second pixel value through the following equation (3) by using a second pixel value a₂ being the pixel value of the pixel and a reference pixel value m₂. The reference pixel value m₂ may be an average pixel value of the spinal canal region in the second image, or a representative value (about 40 HU) as an average CT value in the spinal canal when unaffected by beam hardening artifacts. A preset value other than the average pixel value of the spinal canal region may also be used.

$${b}_{2} = W ( {a}_{2} - {m}_{2} , {μ}_{2} ) \qquad ( 3 )$$

In equation (3) above, W(a, μ) is an activation function that smoothly decays when a is small around the reference value μ as illustrated in FIG. 10, for example. Pixel values in a region affected by the beam hardening artifacts tend to be smaller than pixel values in a region unaffected by the beam hardening artifacts. Therefore, in order to reduce the confidence level of pixel values of a beam hardening artifact generation site, the reference value μ₂ is set to a smaller value (for example, about 0 HU) unlike in the case of the first confidence level estimation unit 202.

The above method for calculating the confidence level of the second pixel value is merely an example, and the second confidence level estimation unit 203 may calculate the confidence level of the second pixel value by other methods. For example, the second confidence level estimation unit 203 may use, as the activation function, a function in which a linearly decreases around the reference value μ as shown in equation (4) below.

$$W ( a , μ ) = max ( min ( ( a + 40 - μ ) / 40 , 1 ) , 0 ) \qquad ( 4 )$$

The above example describes a method for considering the beam hardening artifacts as a noise factor that can affect the second pixel; however, the embodiment is not limited thereto. For example, in consideration of pixel hyperintensity due to metal artifacts, the second confidence level estimation unit 203 may calculate the confidence level of the second pixel value to be low when the pixel value is higher than the average CT value in the spinal canal. In addition to the noise factor illustrated above, the second confidence level estimation unit 203 may also calculate the confidence level of the second pixel value in consideration of the influence of motion artifacts, ring artifacts, banding artifacts, and the like. The second confidence level estimation unit 203 may also calculate the confidence level of the second pixel value by simultaneously considering a plurality of noise factors as well as the method for considering a single noise factor. Specifically, the second confidence level estimation unit 203 may also calculate the confidence level of the second pixel value by independently calculating the confidence level for a plurality of noise factors and integrating (for example, product calculation) the calculated values. In addition, on the basis of a statistical distribution of CT values in the spinal canal when not affected by noise, the second confidence level estimation unit 203 may also calculate the confidence level of the second pixel value from the degree of deviation from the distribution.

### Step S2040

A subtraction value confidence level calculation unit 204 calculates a confidence level b_{d} of a subtraction value between two images, which is calculated at step S2050 to be described below, by using the confidence level b₁ of the first pixel value and the confidence level b₂ of the second pixel value. The pixel value of the first pixel is the first pixel value and the pixel value of the second pixel is the second pixel value. The first pixel and the second pixel are a pixel pair that was corresponded by the registration function 11b1 at step S2011. The confidence level b_{d} is specifically calculated by the following equation (5).

$${b}_{d} = min ( 1 , {b}_{1} + {b}_{2} ) \qquad ( 5 )$$

In equation (5) above, when either one of the confidence level b₁ and the confidence level be is large, the confidence level b_{d} of the subtraction value is also large, and a maximum value thereof is configured to be kept below 1. The equation for calculating the confidence level of the subtraction value is not limited thereto as long as the calculation is based on the confidence level b₁ of the first pixel value and the confidence level be of the second pixel value. For example, equation (6) below can also be constructed using a square root sqrt( ) as in equation (6) below.

$${b}_{d} = min ( 1 , sqrt ( {b}_{1}^{2} + {b}_{2}^{2} ) ) \qquad ( 6 )$$

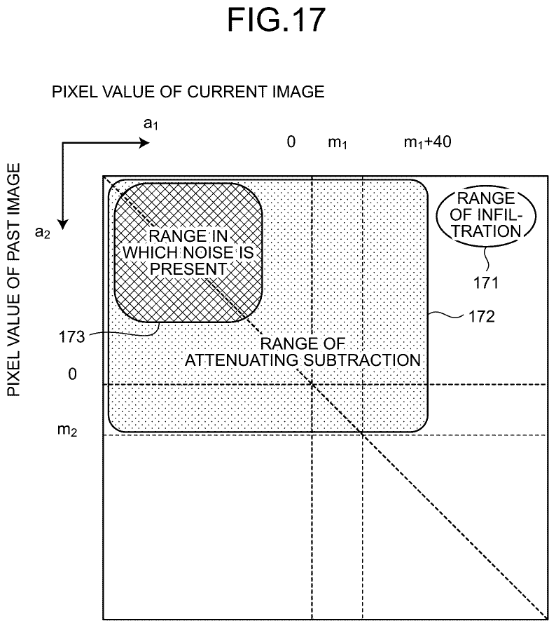

The subtraction value output from the present image processing apparatus 10 is the result of multiplying the original subtraction value by the confidence level b_{d} of the subtraction value. In this way, as illustrated in FIG. 17, the confidence level of the subtraction value can be increased in a range 171 in which infiltration is present, while decreasing the confidence level of the subtraction value in a range 173 in which noise is present. That is, when either the confidence level of the first pixel value or the confidence level of the second pixel value is higher, the confidence level of the subtraction value is increased. This means that the confidence level of the subtraction value is increased when a pixel of the current image is more likely to be a lesion or when a pixel of the past image is less likely to be affected by noise. On the other hand, when both of these confidence levels are low, the confidence level of the subtraction value is decreased. That is, this means that the confidence level of the subtraction value is decreased when the pixel of the current image is less likely to be a lesion and the pixel of the past image is more likely to be affected by noise. The reason why a range 172 of attenuating the subtraction is higher (closer to the right) in the pixel value of the current image is to increase the confidence level of the subtraction value when infiltration is present in the current image even though noise is present in the past image.

With the above intention, this processing step calculates the confidence level of the subtraction value on the basis of the confidence level of the first pixel value and the confidence level of the second pixel value.

The subtraction value confidence level calculation unit 204 may further correct the confidence level of the subtraction value on the basis of the position of each pixel in the patient's body. For example, the subtraction value confidence level calculation unit 204 may calculate a confidence level b′_{d} of the subtraction value by correcting the confidence level of the subtraction value according to an intervertebral foramen level (correction 1) by using the following equation (7) so that the subtraction values of clinically important sites remain intact.

$${b}_{d}^{′} = ( 1 - C ( z ) ) + C ( z ) \times {b}_{d} \qquad ( 7 )$$

In equation (7) above, C(z) is a correction weight coefficient that takes values, for example, as illustrated in FIG. 11, depending on the intervertebral foramen level to which patient coordinates z belong. The intervertebral foramen level represents the division of z-coordinate positions centered on the intervertebral foramen in a craniocaudal direction along the spine, with intervertebral foramen labels C1, C2, . . . , C8, T1, T2, . . . , T12, and L1, L2, . . . , L5. The value of C(z) can be acquired, for example, by reading a value stored in a table for each intervertebral foramen label from the storage circuitry 13 by the subtraction value confidence level calculation function 11e and performing interpolation if necessary. This correction allows a lower confidence contribution rate to be set at clinically important sites on a foot side from T3, enabling a physician to directly view raw subtraction values without noise reduction processing. This can prevent unintentional processing associated with the noise reduction processing from being applied to the subtraction values of the clinically important sites.

The subtraction value confidence level calculation unit 204 may calculate a confidence level b″_{d} of the subtraction value by correcting the confidence level of the subtraction value according to the intervertebral foramen level (correction 2) by using the following equation (8) so that the subtraction values of sites that are not clinically important and prone to noise due to beam hardening artifacts are attenuated.

$${b}_{d}^{″} = {C}^{′} ( z ) \times {b}_{d}^{′} \qquad ( 8 )$$

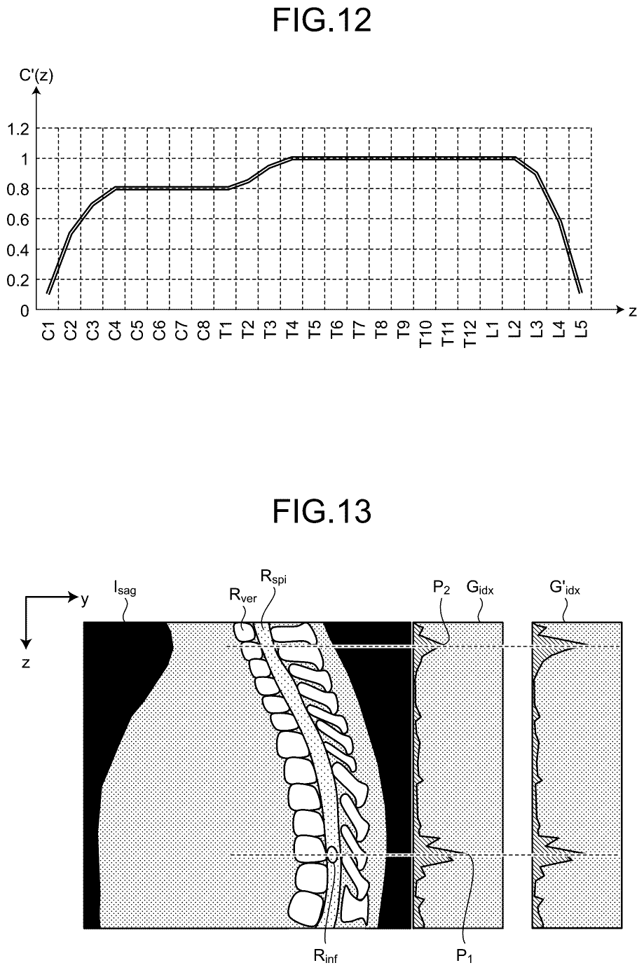

In equation (8) above, C′(z) is a correction weight coefficient that takes values, for example, as illustrated in FIG. 12, depending on the intervertebral foramen level to which the patient coordinates z belong.

The above describes the correction of the confidence level of the subtraction value according to the intervertebral foramen level, but any weighting value may be expressed in terms of the patient coordinates z. For example, the correction of the confidence level of the subtraction value according to vertebral levels can be implemented in the same way. The vertebral levels represent the division of the z-coordinate positions centered on the vertebra in the craniocaudal direction along the spine, with vertebral levels C1, C2, . . . , C7, T1, T2, . . . , T12, and L1, L2, . . . , L5. As in the case of the intervertebral foramen labels, this can be done by referring to the table stored in the storage circuitry 13 by the subtraction value confidence level calculation function 11e.

In addition to the method for performing correction by referring to the table stored in the storage circuitry 13, for example, the subtraction value confidence level calculation function 11e can also directly calculate the weight coefficients required for the correction 1 by using the following equation (9) from the z-coordinate values.

$${C}_{L} ( z ) = max ( min ( ( Z ( T 3 ) - z ) / ( Z ( T 3 ) - Z ( T 2 ) ) , 1 ) , 0 ) \qquad ( 9 )$$

In equation (9) above, Z(T3) is the z-coordinate value of an intervertebral foramen T3 and Z(T2) is the z-coordinate value of an intervertebral foramen T2. Using this weight coefficient C_{L}(z), the subtraction value confidence level calculation function 11e can calculate the corrected confidence level b′_{d} of the subtraction value by using the following equation (10).

$${b}_{d}^{′} = ( 1 - {C}_{L} ( z ) ) + {C}_{L} ( z ) \times {b}_{d} \qquad ( 10 )$$

The above example describes a case in which the subtraction confidence level is corrected on the basis of the position in the patient's body, but the method for correcting the confidence level is not limited thereto. For example, the subtraction value confidence level calculation function 11e may correct values of the first confidence level and the second confidence level on the basis of the position in the patient's body. Specifically, the subtraction value confidence level calculation function 11e may correct the first confidence level to be higher in the lower thoracic to upper lumbar spine sites, in which infiltration is more likely to occur in the spinal canal, than in other sites. The subtraction value confidence level calculation function 11e may also correct the second confidence level to be lower in the upper thoracic to cervical spine sites, in which beam hardening occurs more frequently, than in other sites.

The correction of the confidence level based on the position in the patient's body is not limited to the method based on the patient's position in the craniocaudal direction as described above, but may also be based on the patient's dorsal or ventral position, or based on the patient's left or right position.

The above process of correcting the confidence level does not necessarily have to be performed.

Moreover, the subtraction value confidence level calculation function 11e may calculate the confidence level of the subtraction value according to the vertebral level or the intervertebral foramen level without using the confidence level b₁ of the first pixel value and the confidence level b₂ of the second pixel value. In this case, the subtraction value confidence level calculation function 11e assumes b_{d}=1 and implements the above correction 1 and correction 2.

### Step S2050

A subtraction data calculation unit 205 calculates the subtraction image on the basis of the first image, the deformed image, and the confidence level of the subtraction value. At this time, the subtraction data calculation unit 205 calculates a pixel value d of the subtraction image from the first pixel value a₁ of the first image, the second pixel value a₂ of the deformed image, and the confidence level b_{d} of the subtraction value between the first pixel value and the second pixel value by using the following equation (11), for example. The first pixel exhibiting the first pixel value a₁ and the second pixel exhibiting the second pixel value a₂ are a pixel pair that was corresponded at step S2011. This allows the subtraction data calculation unit 205 to attenuate the subtraction value in a region with a low confidence level on the basis of the confidence level calculated at step S2040.

$$d = ( {a}_{1} - {a}_{2} ) \times {b}_{d} \qquad ( 11 )$$

The method for calculating the pixel value d is not limited to the above example and the subtraction data calculation unit 205 may perform a nonlinear transformation on the confidence level b_{d} of the subtraction value. For example, the subtraction data calculation unit 205 may calculate (a₁−a₂) as a pixel value when the confidence level b_{d} of the subtraction value is higher than a predetermined reference value, and may calculate 0 as the pixel value otherwise. The subtraction data calculation unit 205 may use any “value representing the difference in pixel values” instead of the simple subtraction (a₁−a₂). For example, the subtraction data calculation unit 205 may calculate a value representing the difference in pixel values on the basis of the pixel values of surrounding pixels of each of the first pixel and the second pixel by using the Voxel Matching method or the like.

The subtraction data calculation unit 205 may further assign a prescribed color to the magnitude of the pixel value d of the subtraction image and calculate, as the subtraction data, a fusion image with the assigned color superimposed over the current image.

The subtraction data calculation unit 205 may further use the spinal canal region information being the first target region information to calculate an occupancy rate g(z) using the following equation (12) from a first target region I(z) in a slice including the patient coordinates z and a threshold value T for determining infiltration. Here, [(proposition)] is Iverson's notation, which returns 1 when (proposition) is true and 0 when (proposition) is false.

$$g ( z ) = {\sum }_{p ∈ I ( z )} [ PIXEL VALUE d OF \qquad ( 12 )$$

$$PIXEL p OF DIFFERENCE IMAGE > T ] / {\sum }_{p ∈ I ( z )} 1$$

The subtraction data calculation unit 205 may calculate the occupancy rate calculated in this manner for each of the patient coordinates z, and generate a graph of the results as occupancy rate data with the resulting image displayed alongside a sagittal cross section or a projection image of the fusion image, as illustrated in FIG. 13.

In FIG. 13, I_{sag} represents an image of a sagittal plane in a target image. In the image I_{sag}, Rᵥₑᵣ is the vertebral region, Rₛₚᵢ is the spinal canal region, and R_{inf} is the region of spinal canal infiltration (region of infiltration in the spinal canal). G_{idx} represents an occupancy rate graph and is a graph in which the occupancy rate g(z) representing the degree of infiltration into the spinal canal is plotted along the Z-axis of the image I_{sag} in each axial plane of the target image. At P₁, the occupancy rate graph is higher due to infiltration into the spinal canal, and at P₂, the occupancy rate graph is higher due to noise from beam hardening artifacts. G′_{idx} represents the occupancy rate graph when the confidence level of the subtraction value is not used, and is higher than G_{idx} at P₂.

The subtraction data calculation unit 205 outputs the subtraction image, the fusion image, and the occupancy rate data calculated as described above to an external PACS or the like as subtraction data.

As described above, the image processing apparatus 10 according to the first embodiment allows users such as physicians to perform reading using subtractions without load by excluding the influence of noise. That is, the image processing apparatus 10 according to the first embodiment can be used to solve the problem of not being able to appropriately read an image using subtraction values due to the influence of noise.

First Modification: High-precision Spinal Canal Segmentation during Image Acquisition

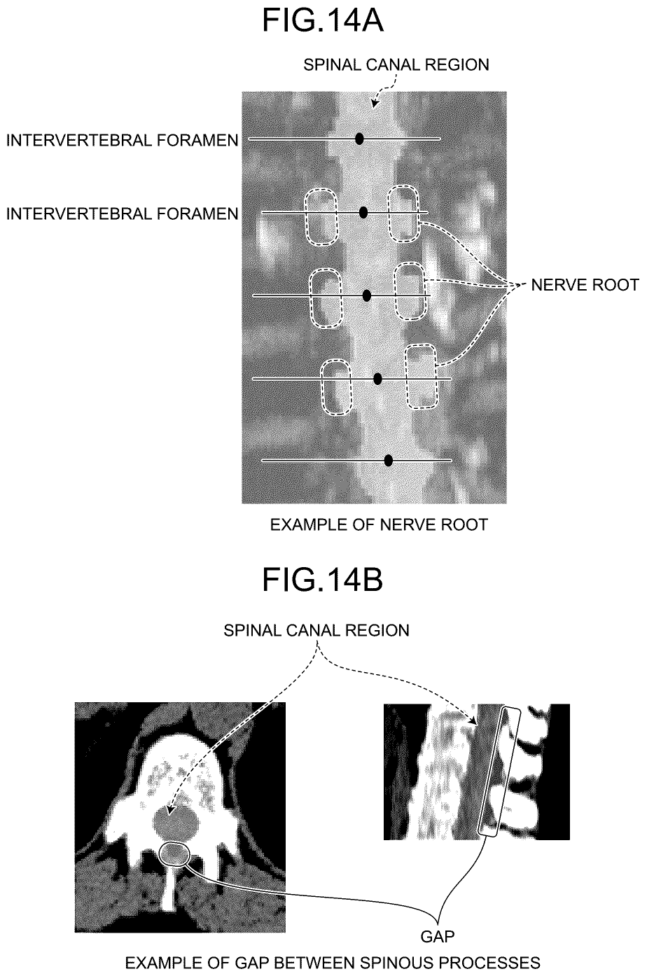

In contrast to the first embodiment, the image acquisition unit 201 may also remove the spinal canal region information that extends into nerve roots as illustrated in FIG. 14A and a gap between spinous processes as illustrated in FIG. 14B. Specifically, with respect to the nerve root as illustrated in FIG. 14A, the image acquisition unit 201 can implement high-precision segmentation by detecting the intervertebral foramen being the cross-hole of the spinal canal, increasing a structural element of an opening operation as it approaches the intervertebral foramen, and shaving off a strongly protruding portion from the spinal canal region information.

As for the gap between the spinous processes as illustrated in FIG. 14B, the image acquisition unit 201 can implement high-precision segmentation by removing locations with low CT values while changing a threshold value depending on the location. Specifically, since the gap between the spinous processes is not large at the cervical spine and upper thoracic spine, the image acquisition unit 201 lowers the threshold value of CT values to be excluded and performs weaker scraping.

Moreover, the image acquisition unit 201 can specify and shave off locations protruding from a cylindrical shape in the spinal canal region information by performing an opening operation on the first target region I(z) in the slice including the patient coordinates z with a structural element whose size is inversely proportional to the circularity defined by the following equation (13).

$$CIRCULARITY = 4 π \times ( AREA OF I ( z ) ) \div {( PERIMETER OF I ( z ) )}^{2} \qquad ( 13 )$$

By making the spinal canal segmentation more precise in this way, the image acquisition unit 201 can more appropriately read the spinal canal infiltration.

In making the spinal canal segmentation more precise, the opening operation may be substituted by other spatial filtering processes. In this case, the size of the structure element more generally corresponds to the size of a spatial filter kernel.

### Second Modification: Visualization of Occupancy Rate of Extraosseous Mass

In contrast to the first embodiment, the image acquisition unit 201 can also visualize the occupancy rate of an extraosseous mass occurring around the vertebrae by setting a target region as a peripheral region of the vertebrae (for example, a region within a predetermined distance R [mm] from the periphery of the vertebrae) instead of the spinal canal. The specific value of R is desirably set not to affect other organs such as the lungs around the vertebrae, and specifically, 5 mm is appropriate. In addition, since the influence of beam hardening artifacts is small for the extraosseous masses, no correction 1 may be performed.

### Third Modification: Example Other Than Spinal Canal

In contrast to the first embodiment, the image acquisition unit 201 can also visualize lesions occurring in the brain parenchyma by using a target region as the brain parenchyma instead of the spinal canal. In the brain parenchyma, the closer to the skull, the more likely it is to be affected by beam hardening artifacts, so it is desirable to calculate the confidence level according to the distance from the skull or correct the confidence level.

### Fourth Modification: Example Other Than Comparison With Average Value

In contrast to the first embodiment, the first confidence level estimation unit 202 and the second confidence level estimation unit 203 can also use other statistics, such as the median or the most frequency value of the pixel values of the spine region, as a value to be compared with each pixel value, in addition to the average pixel value of the spinal canal region.

### Fifth Modification: Example Other Than Beam Hardening Artifacts

In contrast to the first embodiment, the first confidence level estimation unit 202 and the second confidence level estimation unit 203 can also handle noise due to metal artifacts by adjusting the reference value μ. Specifically, the value of the reference value μ needs to be set smaller than in the case of bones because artifacts caused by metal greatly reduce pixel values around the metal compared to bones.

### Second Embodiment

As another embodiment according to the present application, considered is a form in which the subtraction data is displayed in correspondence with the confidence level of the subtraction value.

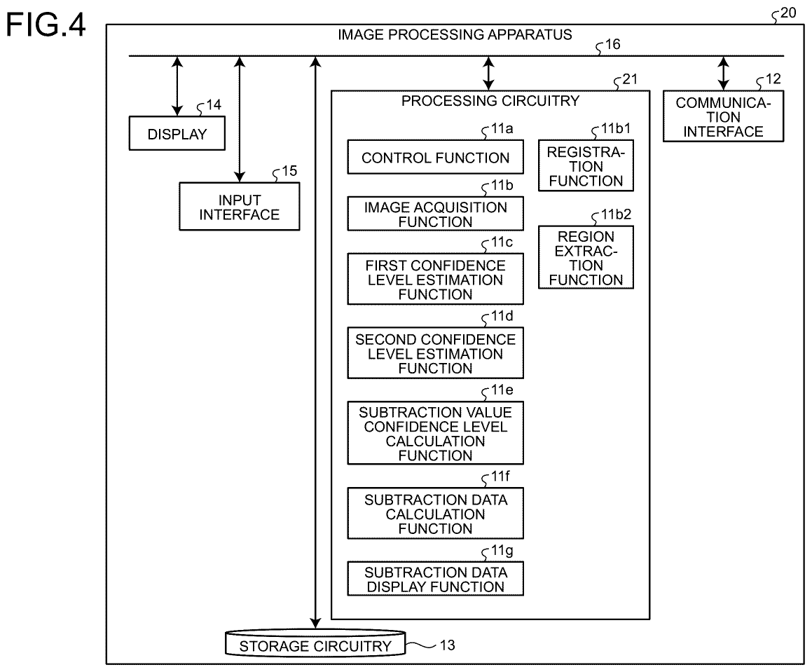

FIG. 4 is a diagram illustrating an example of the configuration of an image processing apparatus 20 according to a second embodiment. The second embodiment is different from the first embodiment in that the image processing apparatus 20a includes processing circuitry 21 in which subtraction data display function 11g is added. Specifically, the subtraction data display function 11g according to the second embodiment displays the subtraction data calculated by the subtraction data calculation function 11f on the display 14 in correspondence with the confidence level of the subtraction value calculated by the subtraction value confidence level calculation function 11e. The subtraction data display function 11g is an example of a subtraction data display unit. These are the main points of description below.

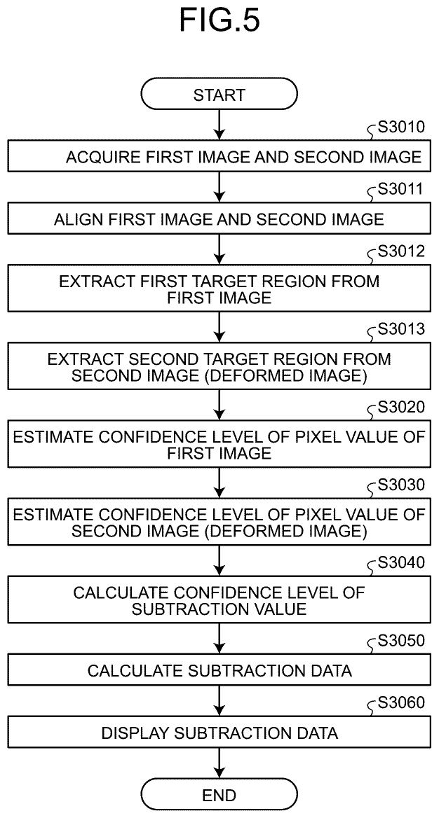

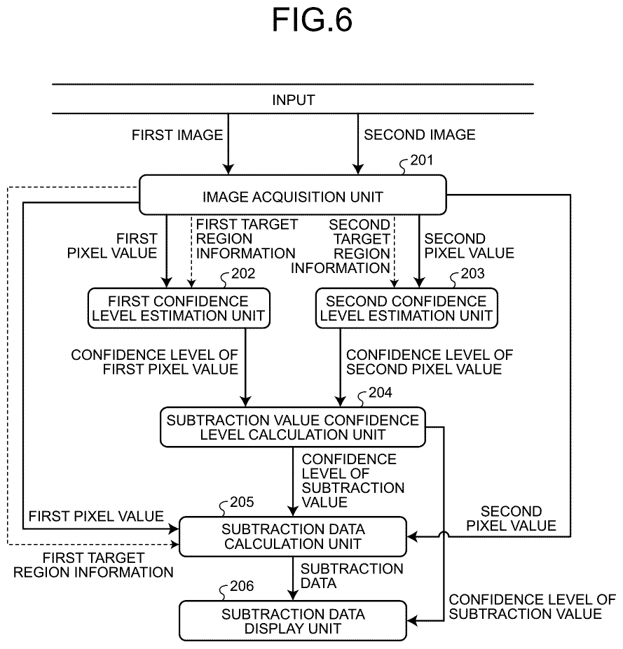

FIG. 5 is a flowchart illustrating a processing procedure performed by the image processing apparatus 20 according to the second embodiment. FIG. 6 is a data flow diagram illustrating an entire procedure of the image processing apparatus 20 according to the second embodiment.

A subtraction data display unit 206 uses, as input, the subtraction data output by the subtraction data calculation unit 205 and the confidence level of the subtraction value output by the subtraction value confidence level calculation unit 204, and displays the subtraction data on the display 14 in a display form corresponding to the confidence level of the subtraction value. In other words, the subtraction data display unit 206 uses, as input, the subtraction data output by the subtraction data calculation unit 205 and the confidence level of the subtraction value output by the subtraction value confidence level calculation unit 204, and displays the subtraction data on the display 14 in correspondence with the confidence level of the subtraction value.

Since processes from step S3010 to S3050 in FIG. 5 are the same as the processes from S2010 to S2050 in FIG. 2 of the first embodiment, a description thereof is omitted. Step S3060 is described below.

### Step S3060

The subtraction data display unit 206 displays the subtraction data, such as the subtraction image, the fusion image, and the occupancy rate data, on the display 14 in a display form that allows a user to visually recognize the confidence level of each subtraction value.

For example, when displaying the fusion image on the display 14, the subtraction data display unit 206 draws an infiltration location 122 or an infiltration location 123 in different colors in correspondence with the confidence levels of individual subtraction values in a spinal canal 121 as illustrated in FIG. 15. That is, the subtraction data display unit 206, for example, draws the infiltration location 123 with a high confidence level brighter than the others, and draws the infiltration location 122 with a low confidence level due to the influence of noise darker than the others.

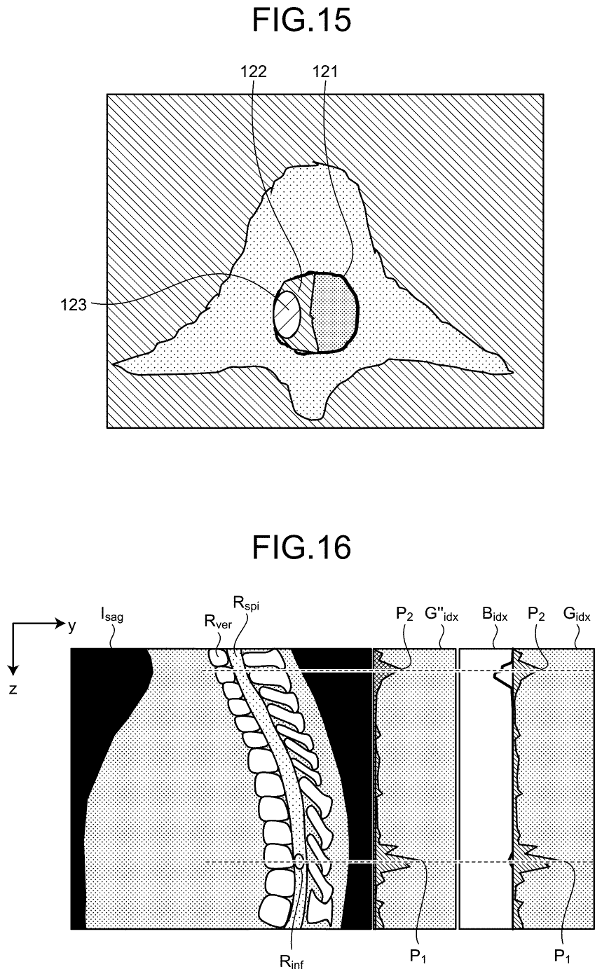

For example, when displaying the occupancy rate data on the display 14, the subtraction data display unit 206 calculates an average confidence level bₘ of the subtraction value within the first target region I(z) in the slice including the patient coordinates z by using the following equation (14), and displays the occupancy rate data on the display 14 in correspondence with a graph G_{idx} of the occupancy rate as in the graph B_{idx} in FIG. 16.

$${b}_{m} ( z ) = {\sum }_{p ∈ I ( z )} ( CONFIDENCE LEVEL {b}_{d} OF \qquad ( 14 )$$

$$DIFFERENCE VALUE OF PIXEL p ) / {\sum }_{p ∈ I ( z )} 1$$

In FIG. 16, B_{idx} represents a graph of the average confidence level, and is a graph in which bₘ(z) representing the average confidence level is plotted along the Z axis of the image I_{sag} in each axial plane of the target image. In FIG. 16, the meanings of the other symbols (signs) are the same as the meanings of the symbols in FIG. 13.

As another display example, the subtraction data display unit 206 draws the graph of the occupancy rate by changing a luminance value as in G″_{idx} in FIG. 16 in correspondence with the average confidence level bₘ. That is, the subtraction data display unit 206 draws the occupancy rate graph at locations with lower average confidence levels, such as P₂, darker than other locations.

As described above, by using the image processing apparatus 20 according to the second embodiment, the confidence level of each subtraction value can be displayed in a way that a user can understand, and the user can appropriately perform reading using the subtraction value.

### Third Embodiment

As another embodiment of the present application, considered is a form in which an inference device obtained by machine learning is used to estimate the confidence level.

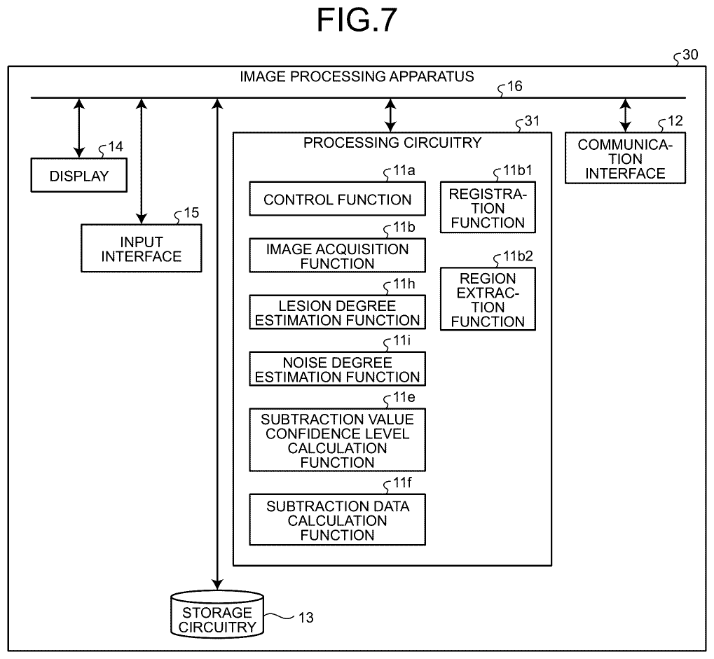

FIG. 7 is a diagram illustrating an example of the configuration of an image processing apparatus 30 according to the third embodiment. The third embodiment is different from the first embodiment in that the image processing apparatus 30 includes processing circuitry 31 in which the first confidence level estimation function 11c is replaced with a lesion degree estimation function 11h and in which the second confidence level estimation function 11d is replaced with a noise degree estimation function 11i. The lesion degree estimation function 11h is an example of a lesion degree estimation unit, and the noise degree estimation function 11i is an example of a noise degree estimation unit. These are the main points of description below.

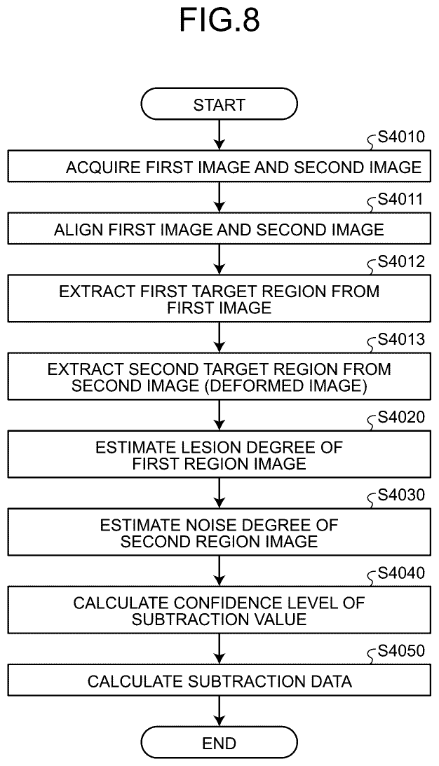

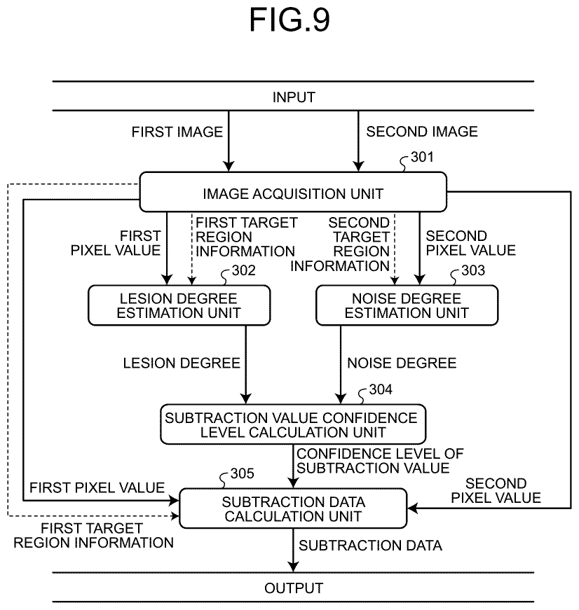

FIG. 8 is a flowchart illustrating an entire procedure of the image processing apparatus 30 according to the third embodiment. FIG. 9 is a data flow diagram illustrating the entire procedure of the image processing apparatus 30 according to the third embodiment.

Since processes from S4010 to S4013 in FIG. 8 are the same as the processes from S2010 to S2013 in the first embodiment, a description thereof is omitted.

In FIG. 8, steps S4020 and S4030 are performed as sequential processes, but may be performed as parallel processes.

### Step S4020

A lesion degree estimation unit 302 estimates a lesion degree b₁ in the first region image by performing inference on the first pixel value in the first region image by using a pre-trained inference device. The inference device can be constructed using known machine learning methods including deep learning or the like. In this case, cases with and without lesions in the spinal canal are assumed to be pre-trained as training data. Statistics of the first target region in the first image, such as the average value, most frequent value, and median value of pixels in the spinal canal region, may also be added as input to the inference device. The lesion degree b₁ calculated in this processing step is a value between 0 and 1 depending on the extent of the lesion, with 1 being calculated for the most lesion-like case and 0 being calculated for the least lesion-like case.

### Step S4030

A noise degree estimation unit 303 estimates a noise degree b₂ in the second region image by performing inference on the second pixel value in the second region image using the pre-trained inference device. The inference device can be constructed using known machine learning methods including deep learning or the like. In this case, cases with and without noise in the spinal canal due to beam hardening artifacts or the like are assumed to be pre-trained as training data. Statistics of the second target region in the second image may also be added as input to the inference device. The noise degree b₂ calculated in this processing step is a value between 0 and 1 depending on the extent of the noise, with 1 being calculated for the most noise-like case and 0 being calculated for the least noise-like case.

### Step S4040

A subtraction value confidence level calculation unit 304 calculates the confidence level b_{d} of the subtraction value by, for example, the following equation (15) by using the lesion degree b₁ and the noise degree b₂. The equation for calculating the confidence level b_{d} of the subtraction value is not limited thereto as long as the confidence level b_{d} is calculated on the basis of the lesion degree b₁ and the noise degree b₂.

$${b}_{d} = min ( 1 , {b}_{1} + ( 1 - {b}_{2} ) ) \qquad ( 15 )$$

The noise degree b₂ is subtracted from 1 in equation (15) above because a larger value reduces the confidence level of the subtraction value.

The subtraction value output from this image processing apparatus 30 is the result of multiplying the original subtraction value by the confidence b_{d} of the subtraction value.

The subtraction value confidence level calculation unit 304 may further correct the confidence level of the subtraction value according to the intervertebral foramen level or the vertebral level as in the first embodiment.

### Step S4050

A subtraction data calculation unit 305 calculates the pixel value of the subtraction image as in the first embodiment. The subtraction data calculation unit 305 may further assign a prescribed color to the pixel value of the subtraction image and calculate, as the subtraction data, a fusion image with the assigned color superimposed over the current image, as in the first embodiment. The subtraction data calculation unit 305 may further calculate the occupancy rate (occupancy rate data) g(z) in the slice including the patient coordinates z, as in the first embodiment.

The subtraction data calculation unit 305 outputs the subtraction image, the fusion image, and the occupancy rate data calculated as described above to an external PACS or the like as subtraction data.

As described above, the image processing apparatus 30 according to the third embodiment allows users such as physicians to perform reading using subtractions without load by excluding the influence of noise. That is, the image processing apparatus 30 according to the third embodiment can be used to solve the problem of not being able to appropriately read an image using subtraction values due to the influence of noise.

### Other Embodiments

In the embodiments described above, the site identification targets are the spinal canal site and the perivertebral site; however, the site identification targets are not limited thereto.

Although the embodiments are described in detail above, the present disclosure can be implemented as a system, an apparatus, a method, a computer program, or a recording medium (storage medium), for example. Specifically, the present disclosure may also be applied to a system including a plurality of devices (for example, a host computer, an interface device, an imaging device, a Web application, and the like) or to a device including one device.

The term “processor” used in the above description of the embodiments means, for example, circuitry such as a central processing unit (CPU), a graphics processing unit (GPU), an application specific integrated circuit (ASIC), or a programmable logic device (for example, a simple programmable logic device (SPLD), a complex programmable logic device (CPLD), and a field programmable gate array (FPGA)). Instead of storing the computer programs in the storage circuitry, the computer programs may be directly incorporated in the circuitry of the processor. In this case, the processor implements functions by reading and executing the computer programs incorporated in the circuitry. Each processor of the present embodiment is not limited to being configured as a single piece of circuitry for each processor, and one processor may be configured by combining a plurality of pieces of independent circuitry to implement the functions thereof.

The image processing program to be executed by the processor is provided by being incorporated in advance in a read only memory (ROM), storage circuity, or the like. The image processing program may be provided by being recorded on a computer readable non-transitory storage medium, such as a compact disc (CD)-ROM, a flexible disk (FD), a CD-recordable (R), and a digital versatile disc (DVD), in a file format installable or executable in these devices. The image processing program may also be provided or distributed by being stored on a computer connected to a network such as the Internet and downloaded over the network. For example, this image processing program is configured as a module including the aforementioned each processing function. As actual hardware, the CPU reads and executes the computer program from the storage medium such as a ROM, so that each module is loaded onto a main storage device and generated on the main storage device.

In addition, in the embodiments described above, each component of each device illustrated in the drawings is a functional concept, and does not necessarily have to be physically configured as illustrated in the drawings That is, the specific form of distribution or integration of each apparatus is not limited to those illustrated in the drawings, but can be configured by functionally or physically distributing or integrating all or part thereof in arbitrary units, depending on various loads and use conditions. Moreover, each processing function performed by each apparatus can be implemented in whole or in part by a CPU and a computer program that is analyzed and executed by the CPU, or by hardware using wired logic.

Of the processes described in the above embodiments and modifications, all or part of the processes described as being performed automatically can be performed manually, or all or part of the processes described as being performed manually can be performed automatically by known methods. Other information including processing procedures, control procedures, specific names, and various data and parameters shown in the above documents and drawings may be changed as desired, unless otherwise noted.

With respect to the above embodiments, the following appendixes are disclosed as an aspect and selective feature of the disclosure.

### Appendix 1

An image processing apparatus provided in one aspect of the present disclosure includes processing circuitry configured to acquire a first image including a first region image in which a common subject is imaged and a second image including a second region image corresponding to the first region image and different from the first image, on the basis of a first pixel value constituting the first region image and a first reference value, estimate a confidence level of the first pixel value, on the basis of a second pixel value constituting the second region image and a second reference value different from the first reference value, estimate a confidence level of the second pixel value, and acquire a confidence level of a subtraction value between the first pixel value and the second pixel value on the basis of the confidence level of the first pixel value and the confidence level of the second pixel value.

### Appendix 2

A pixel value of a first pixel constituting the first region image may be the first pixel value, a pixel value of a second pixel constituting the second region image may be the second pixel value, and the first pixel and the second pixel may be pixels at corresponding positions.

### Appendix 3

The first confidence level estimation unit may estimate the confidence level of the first pixel value on the basis of a standard pixel value of a first target region in the first image including the first region image, the first pixel value, and the first reference value, or the second confidence level estimation unit may estimate the confidence level of the second pixel value on the basis of a standard pixel value of a second target region in the second image including the second region image, the second pixel value, and the second reference value.

### Appendix 4

The image processing apparatus may further include a subtraction data calculation unit that calculates subtraction data generated from the subtraction value, on the basis of the first image, the second image, and the confidence level of the subtraction value.

### Appendix 5

The subtraction value confidence level calculation unit may correct the confidence level of the subtraction value according to a vertebral level or an intervertebral foramen level to which the first region image belongs.

### Appendix 6

The image processing apparatus may further include a subtraction data display unit that displays the subtraction data on a display in correspondence with the confidence level of the subtraction value.

### Appendix 7

The first image and the second image may be images imaged by an X-ray computed tomography (CT) apparatus.

### Appendix 8

The first reference value may be a value determined by a representative pixel value of a lesion occurring in a first target region, and the second reference value may be a value determined by a representative pixel value of a site in which a beam hardening artifact occurs.

### Appendix 9

When a first target region is extracted from the first image including the first region image, the image acquisition unit may change a size of a spatial filtering kernel according to a distance between a spatial filtering target and a neighboring cross-hole.

### Appendix 10

When a first target region is extracted from the first image including the first region image, the image acquisition unit may change a threshold value of the first pixel value regarded as the first target region according to a position in a body axis direction.

### Appendix 11

When a first target region is extracted from the first image including the first region image, the image acquisition unit may change a size of a spatial filtering kernel according to a size of a neighborhood circularity of a spatial filtering target.

### Appendix 12

The second image may be an image taken at a different time from the first image.

### Appendix 13

An image processing method provided in one aspect of the present disclosure includes: acquiring a first image including a first region image in which a common subject is imaged and a second image including a second region image corresponding to the first region image and different from the first image; on the basis of a first pixel value constituting the first region image and a first reference value, estimating a confidence level of the first pixel value; on the basis of a second pixel value constituting the second region image and a second reference value different from the first reference value, estimating a confidence level of the second pixel value; and acquiring a confidence level of a subtraction value between the first pixel value and the second pixel value on the basis of the confidence level of the first pixel value and the confidence level of the second pixel value.

### Appendix 14

A computer program provided in one aspect of the present disclosure is a computer program causing a computer to perform the image processing method according to Appendix 13.

### Appendix 15

An image processing apparatus provided in another aspect of the present disclosure includes: an image acquisition unit configured to acquire a first image including a first region image in which a common subject is imaged and a second image including a second region image corresponding to the first region image; a lesion degree estimation unit configured to estimate a lesion degree of the first region image by using a first inference device on the basis of a first pixel value constituting the first region image; a noise degree estimation unit configured to estimate a noise degree of the second region image by using a second inference device different from the first inference device on the basis of a second pixel value constituting the second region image; and a subtraction data calculation unit configured to calculate a confidence level of a subtraction value between the first pixel value and the second pixel value on the basis of the lesion degree and the noise degree.

### Appendix 16

An image processing apparatus provided in another aspect of the present disclosure includes: an image acquisition unit configured to acquire a first image including a first region image in which a common subject is imaged and a second image including a second region image corresponding to the first region image and different from the first image; and a subtraction value confidence level calculation unit configured to acquire a confidence level of a subtraction value between a first pixel value constituting the first region image and a second pixel value constituting the second region image according to a vertebral level or an intervertebral foramen level to which the first region image belongs.

At least one of the embodiments described above allows users such as physicians to perform reading using subtractions without load by excluding the influence of noise.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus comprising processing circuitry configured to
acquire a first image including a first region image in which a common subject is imaged and a second image including a second region image corresponding to the first region image and different from the first image,
on the basis of a first pixel value constituting the first region image and a first reference value, estimate a confidence level of the first pixel value,
on the basis of a second pixel value constituting the second region image and a second reference value different from the first reference value, estimate a confidence level of the second pixel value, and
acquire a confidence level of a subtraction value between the first pixel value and the second pixel value on the basis of the confidence level of the first pixel value and the confidence level of the second pixel value.

2. The image processing apparatus according to claim 1, wherein a pixel value of a first pixel constituting the first region image is the first pixel value, a pixel value of a second pixel constituting the second region image is the second pixel value, and the first pixel and the second pixel are pixels at corresponding positions.

3. The image processing apparatus according to claim 1, wherein the processing circuitry
estimates the confidence level of the first pixel value on the basis of a standard pixel value of a first target region in the first image including the first region image, the first pixel value, and the first reference value, or
estimates the confidence level of the second pixel value on the basis of a standard pixel value of a second target region in the second image including the second region image, the second pixel value, and the second reference value.

4. The image processing apparatus according to claim 1, wherein the processing circuitry further calculates subtraction data generated from the subtraction value, on the basis of the first image, the second image, and the confidence level of the subtraction value.

5. The image processing apparatus according to claim 1, wherein the processing circuitry corrects the confidence level of the subtraction value according to a vertebral level or an intervertebral foramen level to which the first region image belongs.

6. The image processing apparatus according to claim 4, wherein the processing circuitry further displays the subtraction data on a display in correspondence with the confidence level of the subtraction value.

7. The image processing apparatus according to claim 1, wherein the first image and the second image are images imaged by an X-ray computed tomography (CT) apparatus.

8. The image processing apparatus according to claim 1, wherein the first reference value is a value determined by a representative pixel value of a lesion occurring in a first target region in the first image, and the second reference value is a value determined by a representative pixel value of a site in which a beam hardening artifact occurs.

9. The image processing apparatus according to claim 1, wherein when a first target region is extracted from the first image including the first region image, the processing circuitry changes a size of a spatial filtering kernel according to a distance between a spatial filtering target and a neighboring cross-hole.

10. The image processing apparatus according to claim 1, wherein when a first target region is extracted from the first image including the first region image, the processing circuitry changes a threshold value of the first pixel value regarded as the first target region according to a position in a body axis direction.

11. The image processing apparatus according to claim 1, wherein when a first target region is extracted from the first image including the first region image, the processing circuitry changes a size of a spatial filtering kernel according to a size of a neighborhood circularity of a spatial filtering target.

12. The image processing apparatus according to claim 1, wherein the second image is an image taken at a different time from the first image.

13. An image processing method comprising:
acquiring a first image including a first region image in which a common subject is imaged and a second image including a second region image corresponding to the first region image and different from the first image;
on the basis of a first pixel value constituting the first region image and a first reference value, estimating a confidence level of the first pixel value;
on the basis of a second pixel value constituting the second region image and a second reference value different from the first reference value, estimating a confidence level of the second pixel value; and
acquiring a confidence level of a subtraction value between the first pixel value and the second pixel value on the basis of the confidence level of the first pixel value and the confidence level of the second pixel value.

14. A computer program causing a computer to perform the image processing method according to claim 13.

15. An image processing apparatus comprising processing circuitry configured to
acquire a first image including a first region image in which a common subject is imaged and a second image including a second region image corresponding to the first region image,
estimate a lesion degree of the first region image by using a first inference device on the basis of a first pixel value constituting the first region image,
estimate a noise degree of the second region image by using a second inference device different from the first inference device on the basis of a second pixel value constituting the second region image, and
calculate a confidence level of a subtraction value between the first pixel value and the second pixel value on the basis of the lesion degree and the noise degree.

16. An image processing apparatus comprising processing circuitry configured to
acquire a first image including a first region image in which a common subject is imaged and a second image including a second region image corresponding to the first region image and different from the first image, and
acquire a confidence level of a subtraction value between a first pixel value constituting the first region image and a second pixel value constituting the second region image according to a vertebral level or an intervertebral foramen level to which the first region image belongs.
